(19) United States
(12) Patent Application Publication
(10) Pub. No.: US 2006/0221794 A1
(43) Pub. Date: Oct. 5, 2006

(54) Method and system for playing audio DVD, and method of recording same

(75) Inventor: Zheng-Tie Sun, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/097,275

(22) Filed: Apr. 4, 2005

(51) Int. Cl. G11B 20/12; G11B 7/00

(52) U.S. Cl. 369/59.25; 369/124.07

(57) ABSTRACT

A method of recording a pulse code modulation (PCM) audio on a digital versatile disc (DVD), comprising: inserting the DVD into the optical disc drive; utilizing the laser beam to write a PCM audio data to an audio contents area on the DVD; and writing a PCM audio data to an audio contents area on the DVD utilizing the laser beam, wherein the audio contents area is a fragment or a zone on the DVD, and wherein the DVD is either a DVD-R/-RW or a DVD+R/+RW corresponding to the audio contents area being the fragment or the zone, respectively The invention allows existing PCM audio data stored on a CD to be recorded on a DVD, and provides the playback of the recorded PCM audio data on the DVD.

### BACKGROUND OF THE INVENTION

1. Field of the Invention

The invention relates in general to a method and system for playing a DVD, and more particularly to a method and system for playing an audio DVD.

2. Description of the Related Art

Compact discs (CDs) have become increasingly popular and have in fact been adopted as one of the standard mediums for distributing large quantities of information, whether for holding music, data or computer software. A user, given a computer and an optical disc drive, such as a CD-R, can readily create CDs to include any information as desired. For example, audios on an audio CD are typically recorded by pulse code modulation (PCM), through which the user can record on an average of up to 74 minutes of quality music on a conventional 640 megabytes CD.

PCM (pulse code modulation) is a digital scheme for transmitting analog data. The signals in PCM are binary; that is, there are only two possible states, represented by logic 1 (high) and logic 0 (low). This is true no matter how complex the analog waveform happens to be. Using PCM, it is possible to digitize all forms of analog data, including full-motion video, voices, music, telemetry, and virtual reality (VR).

To obtain PCM from an analog waveform at the source (transmitter end) of a communications circuit, the analog signal amplitude is sampled (measured) at regular time intervals. The sampling rate, or number of samples per second, is several times the maximum frequency of the analog waveform in cycles per second or hertz. The instantaneous amplitude of the analog signal at each sampling is rounded off to the nearest of several specific, predetermined levels. This process is called quantization. The number of levels is always a power of 2—for example, 8, 16, 32, or 64. These numbers can be represented by three, four, five, or six binary digits (bits) respectively. The output of a pulse code modulator is thus a series of binary numbers, each represented by some power of 2 bits.

At the destination (receiver end) of the communications circuit, a pulse code demodulator converts the binary numbers back into pulses having the same quantum levels as those in the modulator. These pulses are further processed to restore the original analog waveform.

FIG. 1 (PRIOR ART) shows tracks on a conventional audio CD. An audio CD typically has a plurality of spiral tracks of PCM audio data, circling from the inside towards outside of the disc. The track is in turn made up of pits and lands (not shown), for recording bits of data that constitute a PCM audio data. To record more than one PCM audio data on the CD, i.e. to record many songs, the PCM audio data are recorded sequentially on the track, such that for a CD containing three songs, for instance, the first song would be found closest to the inner track of the CD, and the second and third songs would be found sequentially disposed on the second track and third track, respectively.

However, while CDs provide as a great utility for recording music, with the inauguration of better formats of optical discs on the market, namely DVDs that boast higher recording capacity, users tend to find the experience frustrating when not being able to transfer PCM audio data originally recorded as tracks on multiple CDs onto a single DVD. That is, transferring PCM audio data from CDs to DVDs is not an available option to users.

### SUMMARY OF THE INVENTION

It is therefore an object of the invention to provide a method of recording a PCM audio data on a DVD, such that users can utilize DVDs to conveniently store PCM audio data from multiple audio CDs onto a single DVD. It is another object of the invention is to provide a DVD playback system for playing a PCM audio data on a DVD, and a method thereof, such that users can playback the PCM audio data recorded on the DVD.

The invention achieves the above-identified objects by providing a method of recording a pulse code modulation (PCM) audio on a digital versatile disc (DVD), adapted for an optical disc drive that includes an optical pick-up assembly. The method includes: inserting the DVD into the optical disc drive; next, utilizing the laser beam to write a PCM audio data to an audio contents area on the DVD; and writing a PCM audio data to an audio contents area on the DVD utilizing the laser beam, wherein the audio contents area is a fragment or a zone on the DVD, and wherein the DVD is either a DVD-R/-RW or a DVD+R/+RW corresponding to the audio contents area being the fragment or the zone, respectively.

The invention also provides a DVD playback system, for playing a PCM audio data on a DVD, including a button set, an optical pick-up assembly, a controller, a decoder, and an audio jack. The button set is operable by a user to instruct commands. The optical pick-up assembly is for reading the DVD, which includes a plurality of audio contents areas, where each audio contents area is a fragment or a zone on the DVD. The controller is to, in response to the commands, utilize the optical pick-up assembly to reproduce a PCM audio data from one of the content areas on the DVD. The decoder is coupled to the controller, and is for reconstructing the PCM audio data from the decoded audio data. The audio jack is to output the decoded audio data reconstructed from the decoder.

The invention achieves the above-identified objects in addition by providing a method of playing a PCM audio data stored on a DVD. The method includes: receiving commands instructed by a user for playing the PCM audio data stored on the DVD; then, reading the DVD, wherein the DVD includes a plurality of audio contents area DVD, wherein the audio contents area is a zone if the DVD is DVD-R/-RW or DVD+RW, and is a fragment if the DVD is a DVD+R; next, accessing one of the audio contents areas on the DVD to reproduce a PCM audio data; then, reconstructing the decoded audio data from the PCM audio data; and, outputting the decoded audio data for playing the same.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (PRIOR ART) shows a data track on a conventional CD.

FIGS. 2A and 2B show audio DVDs on a DVD+R and a DVD-R/-RW/+RW format DVD, respectively according to a preferred embodiment of the invention.

FIG. 3 shows a method of recording PCM audio data on a digital versatile disc according to an embodiment of the invention.

FIG. 4 illustrates a DVD playback system 400 according to a preferred embodiment of the invention.

FIG. 5 shows a method of playing a PCM audio data stored on a DVD according to a preferred embodiment of the invention.

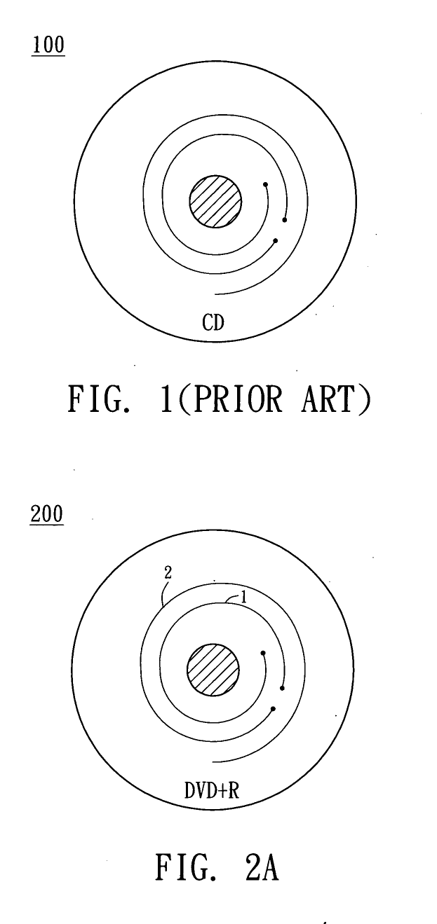

### DETAILED DESCRIPTION OF THE INVENTION

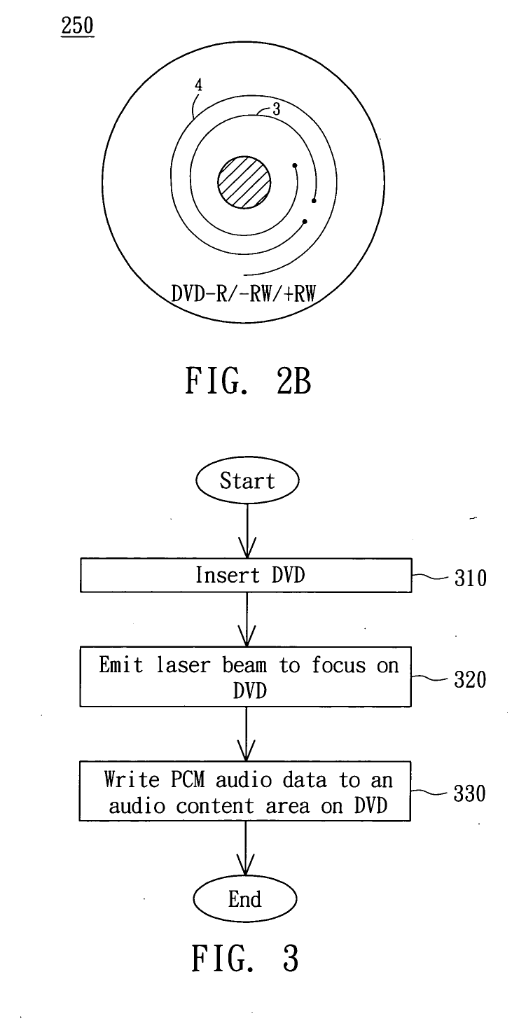

FIGS. 2A and 2B show audio DVDs on a DVD+R and a DVD-R/-RW/+RW disc, respectively according to a preferred embodiment of the invention. As shown in FIG. 2A, audio contents areas on the DVD+R are being organized into fragments, such as fragments 1, and 2, and are disposed in a pattern shown in the figure. A PCM audio data, such as a song, is recorded in fragment 1, and another PCM audio data, such as of another song, is recorded in fragment 2. Similarly, in FIG. 2B, audio contents areas on the DVD-R/-RW/+RW is organized into zones, such as zones 3 and 4, or more commonly referred to as Rzones, and are being disposed in a pattern as shown in FIG. 2B. The PCM audio data are then to be recorded in zones 3 and 4, not necessarily in that sequence of order. Each audio contents area, a fragment on DVD+R or a zone on DVD-R/-RW/+RW, is for recording audios, ranging from a song to a voice recording, and the audio contents areas together allows the recording of a large quantity of audio data. For example, a 4.7 G audio DVD according to the embodiment can record songs more than 500 minutes with the same quality of conventional audio CD.

FIG. 3 shows a method of recording PCM audio data on a digital versatile disc according to an embodiment of the invention, which is applied to an optical disc drive that includes an optical pick-up assembly. The optical disc drive is a DVD+R drive or a DVD-R/-RW/+RW drive. The method of the embodiment begins at step 310, when a DVD is being inserted into the optical disc drive.

Once DVD is inserted, step 320 is performed by utilizing the optical pick up assembly to emit a laser beam, and focusing the laser beam on the DVD. Then, the laser beam is utilized to write a PCM audio data onto an audio contents area on the DVD in step 330. If the DVD is a DVD+R, then the audio contents area is a fragment of the DVD+R; if the DVD is a DVD-R/-RW/+RW, then the audio contents area is a zone of the DVD-R/-RW/+RW, as indicated in FIGS. 2A and 2B.

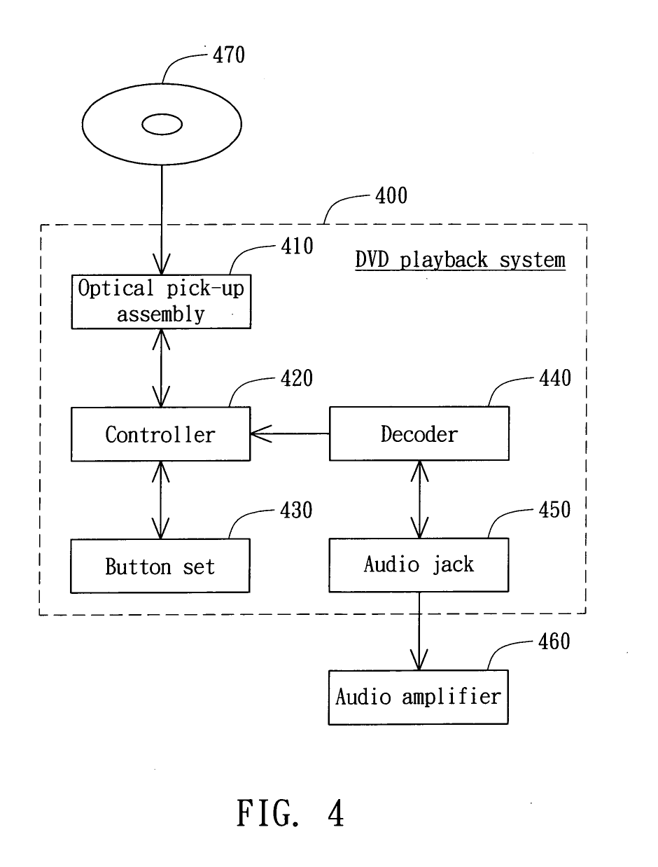

FIG. 4 illustrates a DVD playback system 400 according to an embodiment of the invention. DVD playback system 400, as shown in the figure, can be applied in playing PCM audio data on a DVD 470, and includes an optical pick-up assembly 410, a controller 420, a button set 430, a decoder 440, and an audio jack 450. Button set 430 is coupled to controller 420, and is operable by a user to instruct commands for operating DVD 470. DVD 470 includes a plurality of audio contents areas, and optical pick-up assembly 410 is for reading the audio contents areas on the DVD 470.

Coupling to both optical pick-up assembly 410 and button set 430, controller 420 is for utilizing the optical pick-up assembly to reproduce a PCM audio data from one of the audio contents area on DVD 470. In addition, decoder 440 is also coupled to controller 420, and is for reconstructing the decoded audio data from the PCM audio data received from controller 420. Audio jack 450, coupling to decoder 440, is for receiving the decoded audio data, and outputting the decoded audio data to be played by an audio amplifier 460.

In addition to instructing a command for playing a PCM audio data stored on the DVD, the user can also instruct a pause command to be sent to the decoder for pausing the PCM audio data playback. In such circumstances, as reacting to the pause command, the PCM audio data is paused from playing. Also, the user can further instruct a stop command to stop the DVD from playing the PCM audio data.

Additionally, the user can instruct a next command to controller 420 to play a next PCM audio data; that is, to skip the current song and play a next song on the DVD. The audio contents area as mentioned above, more specifically, is a fragment or a zone on the DVD. Namely, if the DVD is a DVD+R, then the audio contents area is the fragment of the DVD+R, and if the DVD is a DVD-R/-RW/+RW, then the audio contents area is the zone of the DVD-R/-RW/+RW.

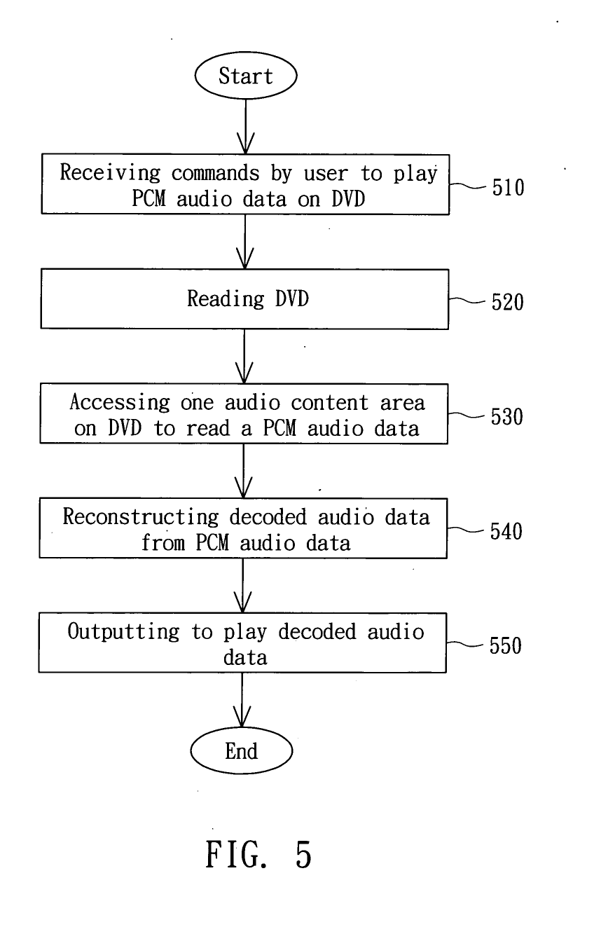

FIG. 5 shows a method of playing a PCM audio data stored on a DVD according to an embodiment of the invention. The method begins at 510, in which commands instructed by a user is received to play PCM audio data stored on DVD 470. Next, step 520 is performed for reading DVD 470. The DVD includes a plurality of audio contents area, such that preferably, DVD 470 is DVD+R/+RW or DVD-R/-RW. Following step 520, step 530 is performed to access one of the audio contents areas on the DVD, for reproducing a PCM audio data. Once the PCM audio data is retrieved, then, in step 540, the decoded audio data is reconstructed according to the PCM audio data. Lastly, in step 550, after being reconstructed, the decoded audio data is then outputted, and to be played by, for example, an external audio amplifier.

The proposed method and system of playing an audio DVD 470, and method of recording the PCM audio data on the DVD 470 according to the embodiment of the invention is advantageous being in that a filing system typically used for DVD-audio, such as a UDF filing system, is not required to record audio information. In other words, the proposed method of recording PCM audio data on a DVD 470 according to the embodiment of the invention is distinguishable from the conventional DVD-audio as PCM audio data are recorded as raw data onto the DVD 470, rather than utilizing a file system to allocate locations for PCM audio recording.

Consequently, according to the embodiment of the invention, users can apply the method of recording the PCM audio data on a DVD to conveniently store PCM audio data from multiple audio CDs onto a single DVD. The user then can utilize the embodiment of the invention, being in the method and system of playing an audio DVD, to playback the PCM audio data on the DVD in which he/she recorded. By doing so as described, not only that the embodiment of the invention provides for easier handling and carry by integrating multiple CDs to one DVD, but the user can record PCM audio data on a DVD that is multiple times larger than a conventional 74 minutes worth of audio allowable on a CD.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of recording a pulse code modulation (PCM) audio on a digital versatile disc (DVD), applied in an optical disc drive including an optical pick-up assembly, the method comprising:
inserting the DVD into the optical disc drive;
emitting a laser beam by the optical pick up assembly to focus on the DVD; and
writing a PCM audio data to an audio contents area on the DVD utilizing the laser beam;
wherein the audio contents area is a fragment or a zone on the DVD.

2. The method according to claim 1, wherein the DVD is a DVD+R and the audio contents area is the fragment of the DVD+R.

3. The method according to claim 1, wherein the DVD is a DVD-R/-RW/+RW and the audio contents area is the zone of the DVD-R/-RW/+RW.

4. A DVD playback system, for playing a PCM audio data on a DVD, comprising:
a button set, coupling to the controller, operable by a user to instruct commands;
an optical pick-up assembly, for reading the DVD, the DVD comprising a plurality of audio contents areas;
a controller, for utilizing the optical pick-up assembly to reproduce a PCM audio data from one of the audio contents areas on the DVD in response to the commands;
a decoder, coupling to the controller, for reconstructing a decoded audio data from the PCM audio data; and
an audio jack, coupling to the decoder, for outputting the decoded audio data;
wherein the audio contents area is a fragment or a zone on the DVD.

5. The DVD playback system according to claim 4, wherein the DVD is a DVD+R and the audio contents area is the fragment of the DVD+R.

6. The DVD playback system according to claim 4, wherein the DVD is a DVD-R/-RW/+RW and the audio contents area is the zone of the DVD-R/-RW/+RW.

7. The DVD playback system according to claim 6, wherein the button set is operable by the user to instruct a pause command to the decoder to pause the PCM audio data from playing.

8. The DVD playback system according to claim 6, wherein the button set is operable by the user to instruct a stop command to the decoder to stop the PCM audio data from playing.

9. The DVD playback system according to claim 6, wherein the button set is operable by the user to instruct a next command to the controller.

10. A method of playing a PCM audio data stored on a DVD, the method comprising:
receiving commands instructed by a user for playing the PCM audio data stored on the DVD, wherein the DVD comprises a plurality of audio contents area;
accessing one of the audio contents areas on the DVD to reproduce the PCM audio data;
reconstructing a decoded audio data from the PCM audio data; and
outputting the decoded audio data for playing the same.

11. The method according to claim 10, wherein the step of accessing the plurality of audio contents areas on the DVD is to reproduce the PCM audio data from the fragment of the DVD if the DVD is a DVD+R.

12. The method according to claim 10, wherein the step of accessing the plurality of audio contents area on the DVD is to reproduce the PCM audio data from the zone of the DVD if the DVD is a DVD-R/-RW/+RW.

13. The method according to claim 10, wherein the step of outputting is stopped in response to a stop command.

14. The method according to claim 10 further comprising outputting a next PCM audio data in response to a next command.
